(19) United States
(12) Patent Application Publication
(10) Pub. No.: US 2013/0223362 A1
(43) Pub. Date: Aug. 29, 2013

(54) UPLINK RESOURCE ACCESS IN WIRELESS NETWORKS

(71) Applicants: Frank Alfano, Naperville, IL (US); Satish Kanugovi, Bangalore (IN)

(72) Inventors: Frank Alfano, Naperville, IL (US); Satish Kanugovi, Bangalore (IN)

(21) Appl. No.: 13/767,069

(22) Filed: Feb. 14, 2013

(30) Foreign Application Priority Data
Feb. 15, 2012 (IN) 421/DEL/2012

(51) Int. Cl. H04W 72/04

(52) U.S. Cl. CPC H04W 72/04
USPC 370/329

(57) ABSTRACT

The present subject matter discloses systems and methods for uplink resource access in wireless communication networks. In one implementation, the method comprises identifying at least one communication device transmitting low characteristic data based on at least one device identification parameter, and transmitting a resource assignment message to the at least one identified communication device, wherein the resource assignment message is indicative of allocation of uplink resources. The method further comprises receiving data, from the at least one identified communication device, based on the allocation of the uplink resources.

### FIELD OF INVENTION

The present subject matter relates to resource control between a user equipment (UE) and a wireless communication network, and, particularly, but not exclusively, to systems and methods for uplink resource access in wireless communication networks.

### BACKGROUND

Communication devices, such as mobile phones, personal digital assistants, and portable computers, provide users with a variety of wireless communication services and computer networking capabilities. These communication services allow data, for example, documents, to be exchanged between the users. Usually the communication devices transmit data using various wireless communication networks, such as Global System for Mobile Communication (GSM) network, Universal Mobile Telecommunications System (UMTS) network and Wideband Code Division Multiple Access (W-CDMA) network.

In recent times, there has been a rapid increase in the use of communication devices. This has changed the amount of traffic and the pattern of traffic in the wireless communication networks. Further, many conventional communication devices host various smart applications, such as social networking applications, chat clients, instant messengers, e-mail clients, games, office utilities, account synchronizers, browsers, media players, and applications providing news/financial updates. Most of the smart applications are network based applications, which often use background data services, i.e., the smart applications often transmit various types of data over the wireless communication network even without any explicit instructions or inputs from the user. For example, an e-mail client may connect to an e-mail server at periodic intervals to download mails and notify the user of any new received mail. Thus, the communication devices initiate requests to access the wireless communication network at frequent intervals. This has resulted in an increase in the volume of access requests made for accessing the wireless communication networks.

Further, a category of communication devices, referred to as smart devices, such as utility meters and electricity meters, often transmit measurement data to a central server over wireless communication networks. For example, an electricity meter may periodically transmit its reading to a central server without any manual intervention. Usually the smart applications and communication devices which transmit and receive data without any manual intervention are collectively referred to as machine to machine (M2M) applications. The M2M applications typically have low volume of data to transfer. Usually the data transferred by M2M applications is not time sensitive and is in the form of short bursts. The M2M applications also need to initiate requests to access the wireless communication network at periodic intervals to send reports to the server.

Various protocols and channels may be used by the communication devices to connect to the network. For example, in 3rd Generation Partnership Project (3GPP) Long Term Evolution (LTE) the communication devices may request for network access using a random access channel (RACH). Scenarios in which communication devices may use the RACH for network access includes, but is not limited to, initial access of the wireless communication network, request for resource allocation, and handover. When communication devices transmit the same random access preamble code in the same subframe used for RACH, those transmissions collide and the communication devices have to back off for a pre-defined time duration and retransmit their random access preamble codes, which in turn causes a delayed access to the wireless communication network.

### SUMMARY

This summary is provided to introduce concepts related to systems and methods for uplink resource access in wireless communication networks. This summary is neither intended to identify essential features of the claimed subject matter nor is it intended for use in determining or limiting the scope of the claimed subject matter.

In an embodiment, a method for uplink resource access in wireless communication networks comprises identifying at least one communication device transmitting low characteristic data based on at least one device identification parameter, and transmitting a resource assignment message to the at least one identified communication device, wherein the resource assignment message is indicative of allocation of uplink resources. The method further comprises receiving data, from the at least one identified communication device, based on the allocation of the uplink resources.

In accordance with another embodiment of the present subject matter, a computing system configured for managing uplink resource access in wireless communication networks comprises a processor, and a device identification module configured to identify at least one communication device transmitting low characteristic data, based on at least one device identification parameter. The computing system further comprises a resource allocation module configured to transmit a resource assignment message, indicative of allocation of uplink resources to the at least one communication device.

In accordance with another embodiment of the present subject matter, a computer readable medium has a set of computer readable instructions that, when executed, perform acts including. identifying at least one communication device transmitting low characteristic data based on at least one of a device identification parameter and a device subscription parameter, and transmitting a resource assignment message to the at least one identified communication device, wherein the resource assignment message is indicative of allocation of uplink resources.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a system for uplink resource access in wireless communication networks in a communication network environment, in accordance with an embodiment of the present subject matter.

FIG. 2 illustrates an exemplary data flow diagram, in accordance with an embodiment of the present subject matter.

FIG. 3 illustrates the components of the system for uplink resource access in wireless communication networks in a communication network environment, in accordance to an embodiment of the present subject matter.

FIG. 4 illustrates an exemplary method for uplink resource access in wireless communication networks, in accordance with an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Systems and methods for data transfer in wireless communication networks are described. The systems and methods can be implemented in a variety of communication devices or communication network devices or both the communication devices and the communication network devices. The communication devices that can implement the described method(s) include, but are not limited to, mobile phones, hand-held devices, laptops or other portable computers, personal digital assistants (PDAs), notebooks, tablets, network access adaptors and the like. Further, the method may also be implemented by devices capable of exchanging data to provide connectivity to different communicating devices and computing systems. Such devices may include, but are not limited to, data cards, mobile adapters, wireless adapters, routers, and the like. Although the description herein is explained with reference to a communicating device, such as a smart-phone, the described method(s) may also be implemented in any other devices, as will be understood by those skilled in the art.

Additionally, the method can be implemented in any of the wireless communication networks, such as Global System for Mobile Communication (GSM) network, Universal Mobile Telecommunications System (UMTS) network, cdma2000 High rate packet data (HRPD) protocol networks, CDMA2000 1x, Long Term Evolution (LTE) networks, general packet radio service (GPRS) networks, and Wideband Code Division Multiple Access (W-CDMA) network. Although the description herein is with reference to certain networks, the systems and methods may be implemented in other networks and devices, albeit with a few variations, as will be understood by a person skilled in the art.

Conventionally, a communication device, referred to as the user equipment in the 3GPP standards, and henceforth referred to as the UE, initiates a random access procedure to obtain an uplink resource to access the wireless communication network, henceforth referred to as the network. It will be known to those skilled in the art that the UE is also referred to as the mobile station (MS) or the access terminal (AT) based on the protocol of the wireless network. In the initial access, the UE may be configured to select the RACH as an uplink resource for its traffic. The parameters for RACH access procedure may include access slots, preamble scrambling code, preamble signatures, spreading factor for data part, available signatures and sub-channels for each Access Service Class (ASC) and power control information. However, the UE is unaware of the status of the resource and their availability, and thus may persistently request for a resource that may be unavailable. If the resource requested by the UE is not available at a Node B of the network due to congestion, volume of traffic, or some other reasons, the Node B denies the request. Upon denial of the resource, the UE typically backs off for a predetermined amount of time before re-attempting another initial access to request the same resource as previously requested. For example, if the UE has performed a random access procedure to access the RACH and the Node B rejects the access, the UE starts a back-off timer. After expiry of the back-off timer, a persistence check is performed. Based on the result of the persistence check, the UE may perform the random access procedure again to access the RACH either in present transmission time interval (TTI) or later. This increases the delay in uploading the data. Further, persistent request for uplink resources also exacerbates network congestion.

Usually the RACH access procedure is used in various scenarios, such as initial access from disconnected state of the UE, i.e., RRC_IDLE state, or radio failure; handover requiring random access procedure; downlink (DL) or uplink (UL) data arrival during RRC_CONNECTED after the uplink physical channels (UL PHY) have lost synchronization, say due to power save operation; and UL data arrival when are no dedicated scheduling request (PUCCH) channels are available.

There are two forms of the RACH procedure. The first form of the RACH procedure is contention-based, which is applicable to all the four scenarios mentioned above. The second form of the RACH procedure is non-contention based, which is applicable only for handover and DL data arrival. In contention based RACH procedure, the UE usually transmits a random access preamble, usually over a special set of physical layer resources, which may be a group of subcarriers allocated for this purpose. In one implementation, the UE may use a Zadoff-Chu sequence to facilitate decoding of simultaneous transmissions. The Node B may then provide the UE with a random access response, typically sent on a Physical Downlink Control Channel (PDCCH) and within a time window of a few TTI. For initial access, the Node B may convey at least one random access preamble identifier, timing alignment information, initial UL grant, and assignment of temporary Cell Radio Network Temporary Identifier (C-RNTI), which is a dynamic UE identifier. The Node B may address one or more UEs in one random access response. The UE and the Node B may then start the scheduled transmission, for example by conveying a UE identifier, and by using hybrid automatic repeat request (HARQ) and radio link control (RLC) transparent mode on uplink scared channel (UL-SCH). The Node B may further use contention resolution to end the RACH procedure.

The above described approach facilitating multiple attempts may result in severe congestion, specifically in the cells having a large number of UEs. If a resource is congested, the large number of UEs will all make reattempts, resulting in further congestion and even higher interference. Uplink resources, such as RACH are managed by the Node B and while the Node B is aware of the availability of these resources, the Node B is configured only to grant or deny the resource requested by the UE and not indicate availability of the resources to the UEs. Also, there is no mechanism that may enable the Node B to indicate to the UE about the details pertaining to the uplink resources so that the UE may optimize the transmitting of the request for uplink resources.

The present subject matter discloses methods and systems for uplink resource access in wireless communication networks. In one embodiment of the present subject matter, the method for uplink resource access in wireless communication networks includes determining whether a UE hosts a M2M application. In another embodiment, the method may include identifying whether a UE is transmitting low volume data in short bursts and at infrequent time intervals. It should be appreciated by those skilled in the art that though the present subject matter is described in the context of UEs which host M2M applications, the same should not be construed as a limitation. The present subject matter may be also applicable to any UE which has low data rate, transmits data of low time sensitivity, and transmits data at infrequent time intervals and in short bursts.

In one example, the Node B of the wireless network is configured to determine all UEs within a cell of the wireless network which hosts M2M application. As mentioned earlier, certain UEs may be dedicated devices for hosting certain categories of M2M application, for example, gas meters, and electricity meters; whereas other UEs may host various categories of applications. For example, a UE, say a smart-phone, may host various smart applications such as social networking applications, chat clients, instant messengers, e-mail clients, games, office utilities, account synchronizers, browsers, and applications providing news/financial updates; which may connect to the network and push data at periodic intervals. In one implementation, the Node B may identify a UE to host M2M applications based on various device identification parameters like international mobile equipment identity (IMEI). In one example, the Node B may receive the device identification parameters associated with each UE during the registration process of the UE with the network. In another example, the Node B may receive the information related to the UE based on subscription parameters of the UE. The subscription parameters may be understood to be the subscription plan availed by the UE, the data usage limit of the UE, the download and upload speed of the UE, the details and identification of the subscriber, and so on. In one implementation, the subscription parameters may be obtained at the time of purchasing a new subscription plan, and at the time of renewing or upgrading an existing subscription plan.

The Node B may be configured to transmit a resource assignment message, indicative of allocation of uplink resources, to one or a group of UEs hosting M2M applications. In one implementation, the resource assignment message may be sent as a unicast message addressing a single UE; whereas in another implementation, the resource assignment message may be sent as a multicast message addressing a group of UEs.

In another implementation, say the wireless network pertains to 3G-1x technology, the resource assignment message may be indicative of the scheduling of the UEs to utilize the reverse common control channel (R-CCCH) in the reservation access (RA) mode. For the UE to use the RA mode, it needs to inform the network a priori, say during the registration, of its ability and intent to use the RA mode on R-CCCH. In one embodiment, the access network may be configured to transmit a signalling message on the forward link common channel, for example, say the forward link paging channel (F-PCH) or the forward link common assignment channel (F-CACH), to transmit the resource assignment message. On receiving the resource assignment message the UEs may be configured to attempt access to the wireless communication network, and transmit data over the assigned uplink resource.

In another example, say the wireless network pertains to HRPD protocol. In said example, the access network may be configured to identify all UEs, within a cell of the wireless network, which hosts M2M application, based on device identification parameters associated with each UE, which may be received during the registration process of the UE with the network or from the subscription parameters of the UE. In said implementation, the base station may assign a high Apersistence value to prevent access channel transmissions from the UEs hosting M2M applications. In one implementation, the high Apersistence value is set during the HRPD session setup. Based on availability of resources, the base station transmits the resource assignment message, indicative of allocation of uplink resources to the UEs hosting M2M applications. The resource assignment message may contain parameters that enhance the probability of the UE to succeed while contending with other UEs to get access channel resources. The receipt of the resource assignment message by the UEs acts as a trigger to initiate attempt to access the network and transmit data using the uplink resources of the network. Thus the above described methods and systems reduce contention in access of uplink resources of a network by reducing persistent request for uplink resources made by the UEs.

In another example, say the wireless network pertains to 3GPP LTE. In said example, the access network may be configured to identify all UEs, within a cell of the wireless network, which hosts M2M application, based on device identification parameters associated with each UE, which may be received during the registration process of the UE with the network or from the subscription parameters of the UE. In said implementation, the Node B can then schedule the contention free uplink transmission by assigning the preamble code to the UE in the RA Preamble Assignment message. The receipt of the RA preamble assignment can be used by the UE to trigger transmission of data on the uplink.

The above methods and system are further described in conjunction with the following figures. It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

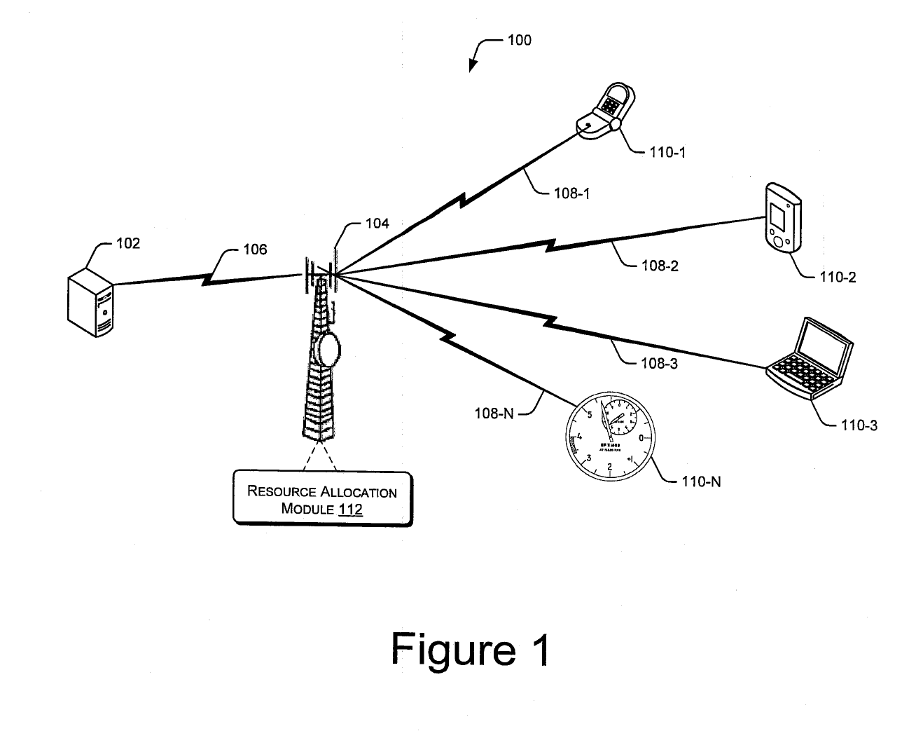

FIG. 1 illustrates a system for uplink resource access in wireless communication networks in a communication network environment 100, in accordance with an embodiment of the present subject matter. In one embodiment, the communication network environment 100 includes a network controller 102, configured to manage one or more Node Bs, such as the Node B 104. The network controller 102 controls and communicates with the Node B 104 using communication links, such as communication link 106. Further the network controller 102 may be implemented as a network server, a server, a workstation, a mainframe computer, and the like. In one implementation, the network controller 102 is configured to control the Node B 104 connected to the network controller 102. The Node B 104 may be further configured to manage resources of the communication network and communicate control signals to and from the network controller 102.

The Node B 104 communicate via radio channels, such as radio channels 108-1, 108-2, 108-3, . . . 108-N, with various user equipments, such as user equipments (UE) 110-1, 110-2, 110-3, . . . 110-N. The UE 110 may include communication devices, such as a mobile phone 110-1, a personal digital assistant 110-2, and a laptop computer 110-3. The UE 110 may also include a desktop computer, a notebook, a smart phone, a network adapter, a data card, a radio receiver unit. Further the UE 110 may be understood to include various dedicated M2M devices, such as energy meter 110-N, which transmit data to a central server, not shown in figure, through the Node B 104. Moreover, the UE 110 may host various smart applications, such as social networking applications, chat clients, instant messengers, e-mail clients, games, office utilities, account synchronizers, and applications providing news/financial updates. Most of smart applications are network based applications which often use background data services, i.e., the smart applications often transmit various types of data using the Node B 104, even without user's perception or knowledge.

In operation, the Node B 104 may be configured to identify all UEs 110, within a cell of the wireless network, which may transfer time insensitive data at periodic intervals, and such UEs 110 are henceforth also referred to as the UEs 110 which host M2M application. In one implementation, the Node B 104 may identify an UE 110 to host M2M applications based on various device identification parameters. In one example, the Node B 104 may receive the device identification parameters associated with each UE 110 during the registration process of the UE 110 with the network. In another implementation, the Node B 104 may identify an UE 110, that is transmitting data in short bursts to the Node B 104 in real time based on the analysis of the traffic pattern of the data packets sent by the UE 110.

In another embodiment, the network controller 102 may be configured to identify all UEs 110, within a cell of the wireless network, which may transfer time insensitive data at periodic intervals, and such UEs 110 are henceforth also referred to as the UEs 110 which host M2M application. In one implementation, the network controller 102 may identify an UE 110 to host M2M applications based on various device identification parameters. In one example, the network controller 102 may receive the device identification parameters associated with each UE 110 during the registration process of the UE 110 with the network. In another implementation, the network controller 102 may identify an UE 110, that is transmitting data in short bursts to the network controller 102 in real time based on the analysis of the traffic pattern of the data packets sent by the UE 110.

For the sake of explanation, the present subject matter is explained in the context of the UEs 110 hosting M2M applications. However, the same should not be construed as a limitation. The present subject matter may be applicable to any UE 110 which may transfer low characteristic data wherein low characteristic data is time insensitive data transmitted by any UE 110 at periodic intervals and in short bursts.

In one implementation, a resource allocation module 112, henceforth referred to as the RAM 112, may be configured to determine network conditions, wherein the network conditions may include the congestion in the network, the utilization of the network, and the availability of resources, such as the uplink resources of the network. Based on the availability of network resources, the RAM 112 may be configured to transmit a resource assignment message, indicative of allocation of uplink resources, to all UEs 110 hosting M2M applications. In said implementation, the resource assignment message, transmitted by the RANI 112, may indicate the scheduling of the UEs 110 to utilize the RCCCH in the reservation access mode or utilize the RCCCH in the basic mode. In one embodiment, the RAM 112 may transmit a signalling message on the F-PCH or F-CACH to transmit the resource assignment message to the UEs 110. On receiving the resource assignment message the UEs 110 may be configured to attempt access to the wireless communication network, and transmit data over the assigned uplink resource.

Further, it should be appreciated by those skilled in the art that the functionalities of the functionalities of the network controller 102 may be implemented as a radio network controller (RNC) or a base station controller (BSC) or a mobile management entity (MME) based on the protocol of the wireless communication network. Similarly, the functionalities of the Node B 104 may be implemented as a base transceiver station (BTS) or a base station (BS) based on the protocol of the wireless communication network.

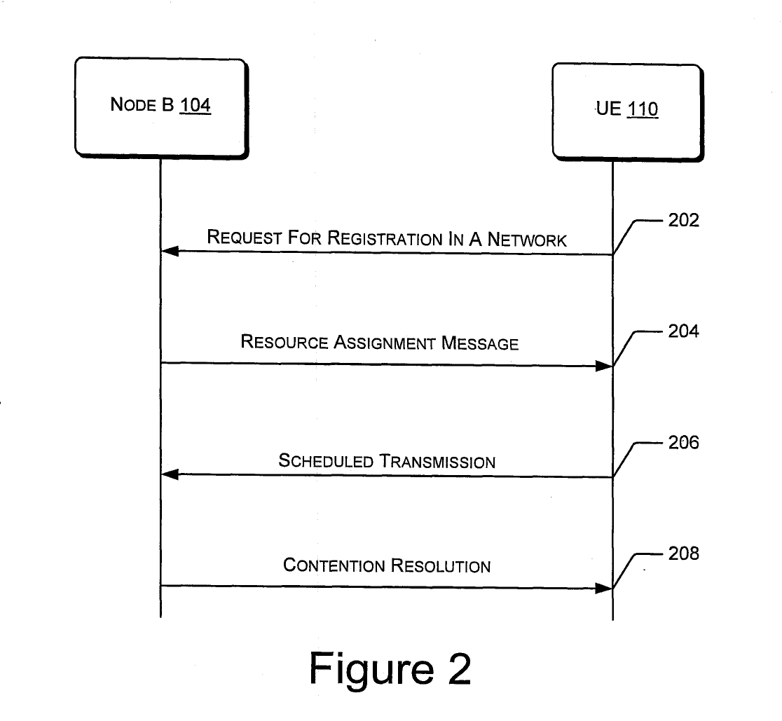

FIG. 2 illustrates an exemplary data flow diagram, in accordance with an embodiment of the present subject matter. The various arrow indicators used in the data flow diagram depict the transfer of data between the UE 110 and the Node B 104.

When the UE 110 is in the network coverage of the Node B 104, the UE 110 transmits a request for registration with the network (step 202). The request for registration of the UE 110 may include various device identification parameters, based on which the Node B 104 may identify the UE 110 as an UE hosting M2M applications or to be a dedicated device for M2M communication, such as an energy meter. As mentioned previously, generally, such UEs 110 have a low data transfer rate. Further, the data to be transferred by such UEs 110 are time insensitive, and occur in short bursts. Moreover such UEs 110 transfer data after considerable time intervals.

Subsequently, the Node B 104 or the network controller 102 analyzes various network parameters, such as congestion in the uplink, congestion in network, and availability of resources. Based on the analysis, the Node B 104 or the network controller 102 schedules the UEs 110 to utilize the RCCCH in the reservation access mode. In one implementation, the Node B 104 may be configured to transmit a resource assignment message, indicative of allocation of uplink resources, to one or a group of UEs 110 hosting M2M applications. In another implementation, the Node B 104 may be configured to transmit a signalling message on the F-PCH or F-CACH to transmit the resource assignment message (step 204).

On receiving the resource assignment message the UEs 110 may be configured to attempt access to the Node B 104 of the wireless communication network, and transmit data to the Node B 104 on being allocated an uplink resource (step 206).

On completion of the transmittal of data, the Node B 104 may transmit a contention resolution message to terminate the connection with the UEs 110 and free the assigned uplink resource (step 208). In another embodiment, the Node B would have pre-determined the number of slots are available for the UE 110 to transmit on the uplink and hence automatically determines the time interval after which the uplink resources reserved for the UE 110 may be freed. The freed uplink resource may now be allocated by the Node B to a different set of identified UEs 110 for uploading data. Thus, the Node B 104 reduces the volume of requests for network access generated by the UEs 110 hosting M2M application and facilitates contention free network access.

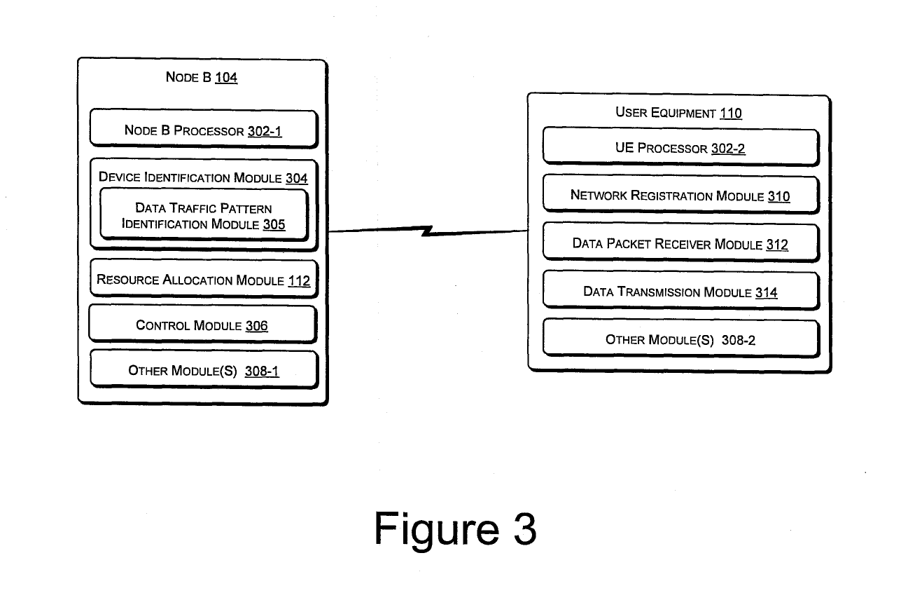

FIG. 3 illustrates the components of the system for uplink resource access in wireless communication networks in a communication network environment 100, in accordance to an embodiment of the present subject matter. In the FIG. 3, the components of the exemplary Node B 104 and the UE 110, in accordance to an embodiment of the present subject matter. In said implementation, the Node B 104 includes a Node B processor 302-1, and the UE 110 includes a UE processor 302-2. The processors 302-1, and 302-2 are collectively referred to as the processors 302 and singularly as the processor 302.

The processor(s) 302 may include microprocessors, microcomputers, microcontrollers, digital signal processors, central processing units, state machines, logic circuitries and/or any other devices that manipulate signals and data based on operational instructions. The processor(s) 302 can be a single processing unit or a number of units, all of which could also include multiple computing units. Among other capabilities, the processor(s) 302 are configured to fetch and execute computer-readable instructions stored in one or more computer readable mediums.

Functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The computer readable medium may include any computer-readable medium known in the art including, for example, volatile memory, such as random access memory (RAM) and/or non-volatile memory, such as flash.

In one implementation, the Node B 104 includes various modules, such as a device identification module 304, the resource allocation module 112, a Control Module 306, and other modules 308-1. In said implementation, the UE 110 includes a network registration module 310, a data packet receiver module 312, a data transmission module 314, and other modules 308-2. The other modules 308-1 and 308-2 may include programs or coded instructions that supplement applications and functions of the Node B 104 and the UE 110 respectively.

The various modules described herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Further the functionalities of various modules may be embodied directly in hardware, in a software module executed by a processor, or in a combination of the two.

In operation, on being in the vicinity of network coverage of a Node B 104, the network registration module 310 attempts to register the UE 110 with the Node B 104. In one implementation, the network registration module 310 may transmit various device identification parameters, such as the International Mobile Equipment Identity (IMEI), and International Mobile Subscriber Identity (IMSI), to the Node B 104. Based on the received parameters, the device identification module 304, of the Node B 104 or the network controller 102 may be configured to identify the UE 304. Further, in one implementation, the device identification module 304 may include a data traffic pattern identification module 305 that may be configured to determine whether the UE 110 hosts M2M applications, i.e., whether the UE 110 transmits time insensitive data at periodic intervals at low data rate and in short bursts. Such a determination may be based on parameters, such as the device identification parameters, sent by UE 110 to the Node B 104 and by analyzing the data packet transmitted by the UE 110.

On identifying all the UEs 110, within a cell, the Control Module 306, may be configured to schedule one or a group of UEs 110 to use the RCCCH in the reservation access mode. In one implementation, the Control Module 306 may transmit a resource assignment message, indicative of allocation of uplink resources, to one or a group of UEs 110 hosting M2M applications. In said implementation, the resource assignment message may be indicative of the scheduling of the UEs 110 to utilize the RCCCH in the reservation access mode or in the basic mode. In another implementation, the resource assignment message may be indicative of the scheduling of the UEs 110 to utilize the reverse access channel. In another implementation, the Control Module 306 may be configured to transmit a signalling message on the forward link paging channel (F-PCH) to transmit the resource assignment message.

The resource assignment message may be received by the data packet receiver module 312 of the UE 110. On receipt of the resource assignment message, the data packet receiver module 312 may trigger the data transmission module 314 to attempt to access the network and transmit data using the allocated uplink resources. On completion of the data transfer, the Control Module 306 may transmit a contention resolution message or a terminating signal to terminate the connection of the Node B 104 and the UE 110 and thus, free the uplink resources. The Node B 104 may also autonomously make a determination that the uplink transmissions from the UE 110 has terminated based on the volume of data usage allotted to the UE 110 by the Node B 104. The freed uplink resource may now be allocated to another UE 110 based on the scheduling. Thus, the Node B 104 reduces the volume of requests for network access generated by the UEs 110 hosting M2M application and facilitates contention free network access.

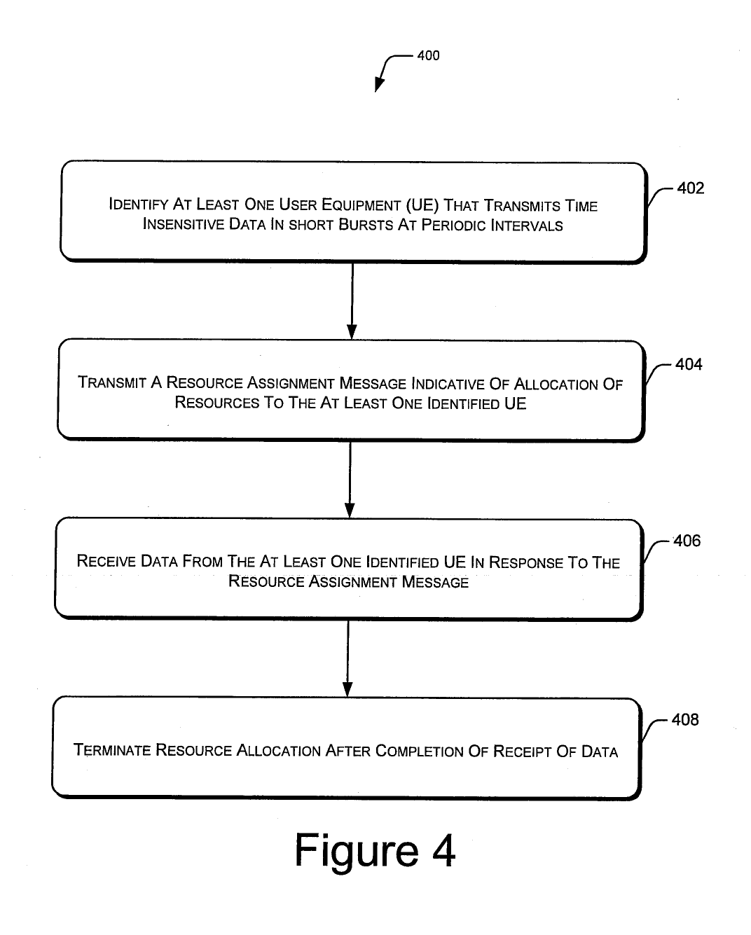

FIG. 4 illustrates an exemplary method 400 for uplink resource access in wireless communication networks, in accordance with an embodiment of the present subject matter, in accordance with another embodiment of the present subject matter. The order in which the method 400 is described is not intended to be construed as a limitation, and any number of the described method blocks can be combined in any order to implement the method 400, or an alternative method. Additionally, individual blocks may be deleted from the method 400 without departing from the spirit and scope of the subject matter described herein. Furthermore, the method 400 may be implemented in any suitable hardware, software, firmware, or combination thereof.

A person skilled in the art will readily recognize that steps of the method 400 can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method 400. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary method 400.

With reference to method 400 as depicted in FIG. 4, as illustrated in block 402, the Node B 104 identifies at least one communication device, such as the UE 110, to be a device that transmits time insensitive data at periodic intervals at low data rate and in short bursts, such as a device hosting a M2M application. In one implementation, the device identification module 304 of the Node B 104 may be configured to identify the UE 110 to be such a device based on device identification parameters.

At block 404, a resource assignment message, indicative of allocation of uplink resources, may be transmitted to all UEs hosting M2M applications. In said implementation, the resource assignment message may be indicative of the scheduling of the UEs 110 to utilize the reverse common control channel (RCCCH), either in the basic or the reservation access mode. In one embodiment, the Control Module 306 may be configured to transmit the resource assignment message to the UEs 110. In another implementation, the Control Module 306 may be configured to transmit a signalling message on the forward link paging channel (F-PCH) or the forward link common assignment channel (F-CACH) to transmit the resource assignment message. The receipt of the resource assignment message by the UE 110 may trigger the UE to transmit data using the allocated uplink resource.

As illustrated in block 406, the data from the UE 110 is received over the allocated uplink resource. In one implementation, the Control Module 306 may be configured to monitor the data upload process from the UE 110.

As depicted in block 408, on completion of the receipt of data, the allocation of the resources is terminated. In one implementation, the Control Module 306 may be configured to transmit a terminating signal to end the data transfer process and thus, free up the allocated uplink resource. In one implementation, the Control Module 306 may further, allocate the freed up uplink resource to a new set of UEs 110 to facilitate data upload from the new set of UEs 110.

Although implementations for uplink resource access in wireless communication networks have been described in language specific to structural features and/or methods, it is to be understood that the same are not necessarily limited to the specific features or methods described. Rather, the specific features and methods are disclosed as exemplary implementations for uplink resource access in wireless communication networks.

1. A method for uplink resource access in a wireless communication network, the method comprising:
identifying at least one communication device transmitting low characteristic data based on at least one device identification parameter;
transmitting a resource assignment message to the at least one identified communication device, wherein the resource assignment message is indicative of allocation of uplink resources; and
receiving data, from the at least one identified communication device, based on the allocation of the uplink resources.

2. The method as claimed in claim 1, wherein the method further comprises terminating the allocation of the uplink resources, on the data being received.

3. The method as claimed in claim 1, wherein the device identification parameters comprise at least one of an International Mobile Equipment Identity, an International Mobile Subscriber Identity, a subscription parameter associated with the at least one communication device, and a data transmission pattern of the at least one communication device.

4. The method as claimed in claim 1, wherein the method further comprises receiving a request from the at least one communication device to register with the wireless communication network.

5. The method as claimed in claim 1, wherein the uplink resources comprise a reverse common control channel accessed in a reservation access (RA) mode.

6. The method as claimed in claim 1, wherein the method further comprises determining network conditions, wherein the network conditions are indicative of at least one of a congestion in a communication network, a utilization of the communication network, and availability of the uplink resources of the communication.

7. The method as claimed in claim 6, wherein the method further comprises,
allocating the uplink resources to the at least one communication device, based on the determination; and
generating the resource assignment message to be transmitted to the at least one communication device, wherein the resource assignment message is indicative of the allocation of uplink resources.

8. A computing system comprising:
a processor;
a device identification module coupled to the processor, the device identification module being configured to identify at least one communication device transmitting low characteristic data, based on at least one device identification parameter; and
a resource allocation module coupled to the processor, the resource allocation module being configured to transmit a resource assignment message, indicative of allocation of uplink resources to the at least one communication device.

9. The computing system as claimed in claim 8, wherein the resource allocation module is further configured to determine network conditions, wherein the network conditions are indicative of at least one of a congestion in a communication network, an utilization of the communication network, and availability of the uplink resources of the communication.

10. The computing system as claimed in claim 9, wherein the resource allocation module is further configured to,
allocate the uplink resources to the at least one communication device, based on the determination; and
generate the resource assignment message to be transmitted to the at least one communication device, wherein the resource assignment message is indicative of allocation of uplink resources.

11. The computing system as claimed in claim 8, wherein the device identification module further comprises a data traffic pattern identification module configured to identify a data traffic pattern generated by the at least one communication device.

12. The computing system as claimed in claim 8, wherein the computing system further comprises a control module configured to free the uplink resources allocated to the each of the identified devices on completion of data transmission by the at least one communication device.

13. A computer-readable medium having embodied thereon a computer program for executing a method comprising:
identifying at least one communication device transmitting low characteristic data based on at least one device identification parameter; and
transmitting a resource assignment message to the at least one identified communication device wherein the resource assignment message is indicative of allocation of uplink resources.
